(19) United States
(12) Patent Application Publication
(10) Pub. No.: US 2018/0311807 A1
(43) Pub. Date: Nov. 1, 2018

(54) Cordless Power Tool and Multi-Purpose Battery Pack System

(71) Applicant: Black & Decker Inc., New Britain, CT (US)

(72) Inventors: Oleksiy P. SERGYEYENKO, Baldwin, MD (US); Justin BARKLEY, Columbia, MD (US); Joseph B. COOPER, Baltimore, MD (US); Timothy W. FRENCH, JR., Hampstead, MD (US); Steven J. PHILLIPS, Ellicott City, MD (US); Philip GILDE, Baltimore, MD (US); Trevor KOENIG, Lancaster, PA (US); Ralphy A. LOUIS, York, PA (US); Daniel J. ALBRECHT, Baltimore, MD (US); Brent A. KUEHNE, Red Lion, PA (US)

(21) Appl. No.: 15/498,469

(22) Filed: Apr. 27, 2017

(51) Int. Cl. B25F 5/02; B25F 3/00; H01M 2/10

(52) U.S. Cl. CPC B25F 5/02; H01M 2/1022; B25F 3/00

(57) ABSTRACT

The present disclosure is directed to a power tool and multi-function battery pack system having a dual latch latching assembly for affixing the battery pack to the power tool.

### RELATED APPLICATIONS

This application claims priority under 35 U.S.C. § 119(e) to U.S. Provisional Patent Application No. 62/327,577, filed Apr. 26, 2016, titled “12V USB Battery.”

### TECHNICAL FIELD

This application relates to a cordless power tool and multi-purpose battery pack system. The system includes a novel tool-battery pack attachment system. The battery pack includes a novel method for charging the battery cells of the battery pack. The battery pack includes novel features for sinking and sourcing energy to and from the battery cells.

### BACKGROUND

Various types of electric power tools are commonly used in construction, home improvement, outdoor, and do-it-yourself projects. Conventional power tools generally fall into two categories—corded power tools that are powered by an AC power source, e.g., an AC mains line, and cordless power tools that are powered by one or more DC power sources, e.g., a rechargeable battery pack.

Corded power tools generally are used for heavy duty applications that require high power and/or long runtimes, such as heavy duty sawing, heavy duty drilling and hammering, and heavy duty metal working. However, as their name implies, corded power tools require the use of a cord that can be connected to an AC power source. In many applications, such as on construction sites, it is not convenient or practical to find a continuously available AC power source and/or AC power must be generated by a portable power supply such as a generator, e.g. gas powered generator.

Cordless power tools generally are used for lighter duty applications that require low or medium power and/or short runtimes, such as light duty sawing, light duty drilling, and fastening. As cordless tools tend to be more limited in their power and/or runtime, they have not generally been accepted by the industry for all applications. They are also limited by weight since the higher capacity batteries tend to have greater weight, creating an ergonomic disadvantage.

### SUMMARY

Instead of having a first type of battery for operating a set of cordless power tools and a second type of battery for operating a battery based portable power supply, one aspect of the present invention is to provide a battery based portable power supply having an electromechanical interface configured to mate with a removable battery pack. The removable battery pack has an electromechanical interface configured to mate with the portable power supply electromechanical interface and an electromechanical interface of a set of cordless power tools. In other words, the portable power supply electromechanical interface is identical to the electromechanical interface of the set of cordless power tools. As such, the removable battery pack is able to provide power to both the portable power supply and the cordless power tools. The portable power supply may be configured with a single interface to receive a single battery pack or may be configured with a plurality of interfaces to receive a corresponding plurality of battery packs.

An aspect of the present invention includes a power tool and battery pack system, comprising a power tool having a latching assembly comprising a pair of buttons, each button coupled to a corresponding latch, wherein moving the buttons towards each other moves the latches away from each other, a battery pack comprising a pair of catches, wherein the catches are positioned on opposing sides of the battery pack to receive the latches to affix the battery pack to the power tool.

These and other advantages and features will be apparent from the description and the drawings.

### BRIEF DESCRIPTION OF THE DRAWINGS

FIG. 1 illustrates a first exemplary embodiment of a cordless power tool and multi-purpose battery pack system including a first exemplary battery pack and a first exemplary set of cordless power tools.

FIG. 2 illustrates a perspective view of the battery pack of FIG. 1.

FIG. 3 illustrates a second perspective view of the battery pack of FIG. 1.

FIGS. 4A and 4B illustrate top and bottom perspective views of an exemplary set of battery cells and components of the battery pack of FIG. 1.

FIG. 5 illustrates a perspective view of a housing of one of the exemplary power tools of FIG. 1.

FIG. 6 illustrates an exemplary latching assembly of the power tools of FIG. 1.

FIG. 7A illustrates cross section view of a battery pack and a power tool of FIG. 1 having the power tool latching assembly engaged with the battery pack.

FIG. 7B illustrates a cross section view of a battery pack and a power tool of FIG. 1 having the power tool latch assembly disengaged with the battery pack.

FIG. 8 illustrates a front elevation view of a power tool and battery pack of FIG. 1 prior to engagement.

FIG. 9 illustrates a perspective view of mechanical mating interface of a power tool of FIG. 1.

FIG. 10 illustrates a perspective view of a battery pack of FIG. 1 coupled to a rechargeable battery operated electronic device.

FIG. 11 illustrates an exemplary simplified block diagram of the battery pack of FIG. 1.

FIG. 12 illustrates a flow chart of a charging and discharging scheme of the battery pack of FIG. 1.

FIG. 13 illustrates a bottom, right perspective view of a second, exemplary cordless power tool of a set of cordless power tools.

FIG. 14 illustrates a bottom, left perspective view of a tool foot/battery pack mechanical interface of the power tool of FIG. 13.

FIG. 15 is a top, right perspective view of the tool foot/battery pack mechanical interface of the power tool of FIG. 13.

FIG. 16A is a top, right perspective view of the latch assembly and terminal block of the power tool of FIG. 13.

FIG. 16B is a front elevation view of the latch assembly and terminal block of the power tool of FIG. 16.

FIG. 16C is a top plan view of the latch assembly and terminal block of the power tool of FIG. 13.

FIG. 16D is a bottom plan view of the latch assembly and terminal block of the power tool of FIG. 13.

FIG. 16E is a left side elevation view of the latch assembly and terminal block of the power tool of FIG. 13.

FIG. 16F is a right side elevation view of the latch assembly and terminal block of the power tool of FIG. 13.

FIG. 16G is a section view along line W-W of FIG. 16B.

FIG. 17 is a top, right perspective view of a second exemplary battery pack for use with the cordless power tool of FIG. 13.

FIG. 18 is a top, left perspective exploded view of the battery pack of FIG. 17.

FIG. 19 is a top, left perspective view of a tool foot of the power tool of FIG. 13 and the battery pack of FIG. 17 prior to mating/coupling.

FIG. 20 is top, right perspective view of the tool foot and battery pack of FIG. 19 after mating/coupling.

FIG. 21 is a right side elevation view of the tool foot and battery pack of FIG. 20.

FIG. 22 is a section elevation view of FIG. 21 along line W-W illustrating the latch assembly engaged with the battery pack.

FIG. 23 is a section elevation view of FIG. 21 along line W-W illustrating the latch assembly disengaged from the battery pack.

FIG. 24 is an exemplary simplified block diagram of the battery pack of FIG. 17.

FIGS. 25A, 25B, and 25C are a flowchart illustrating an exemplary charging scheme of the battery pack of FIG. 17.

FIGS. 26A and 26B are a flowchart illustrating an exemplary discharging scheme of the battery pack of FIG. 17.

### DETAILED DESCRIPTION

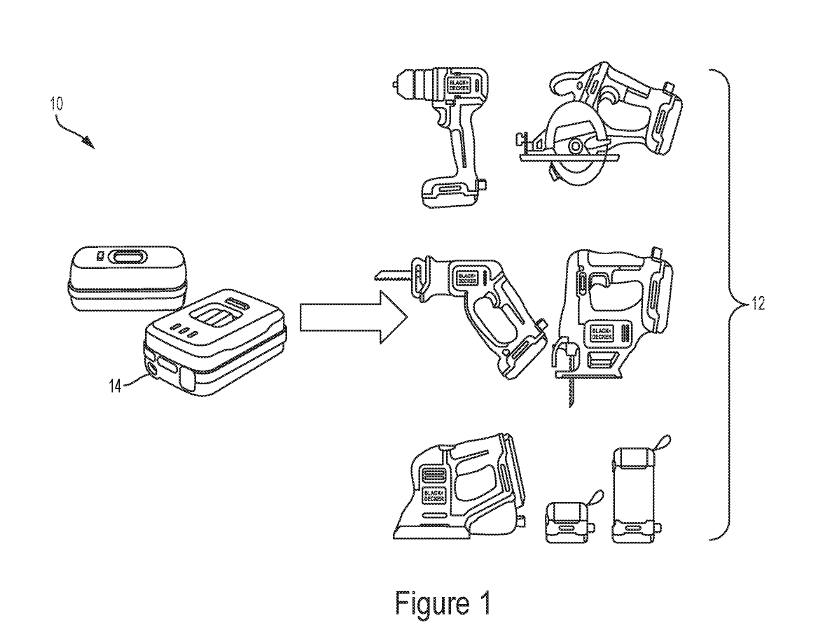

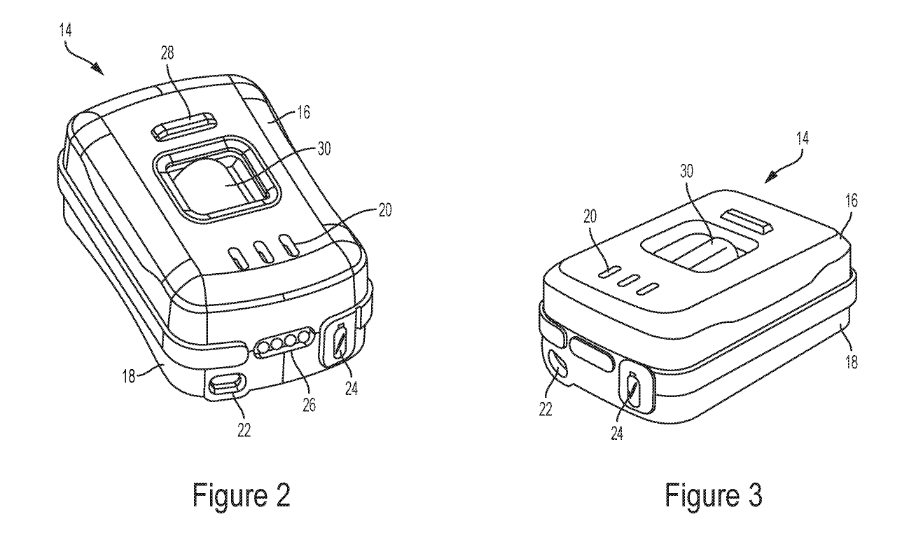

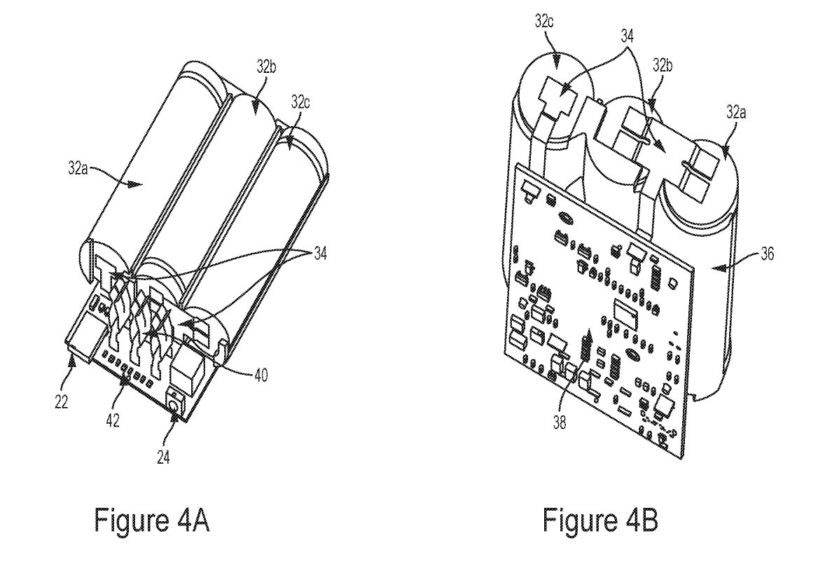

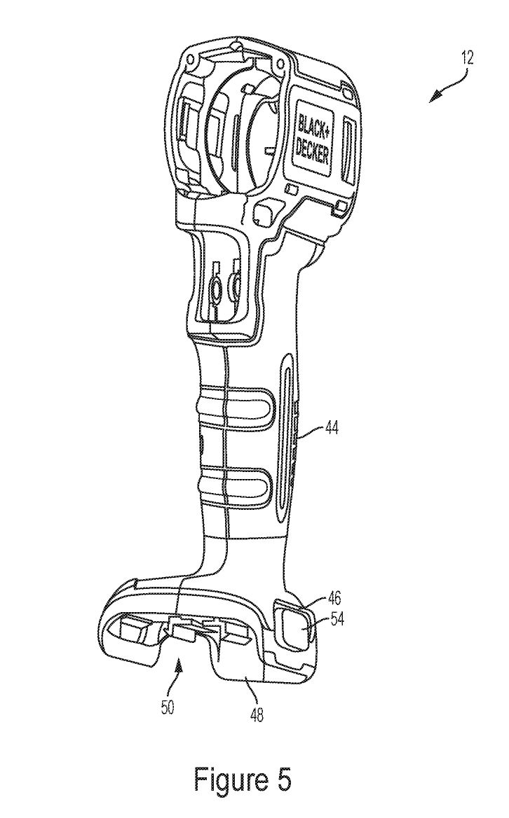

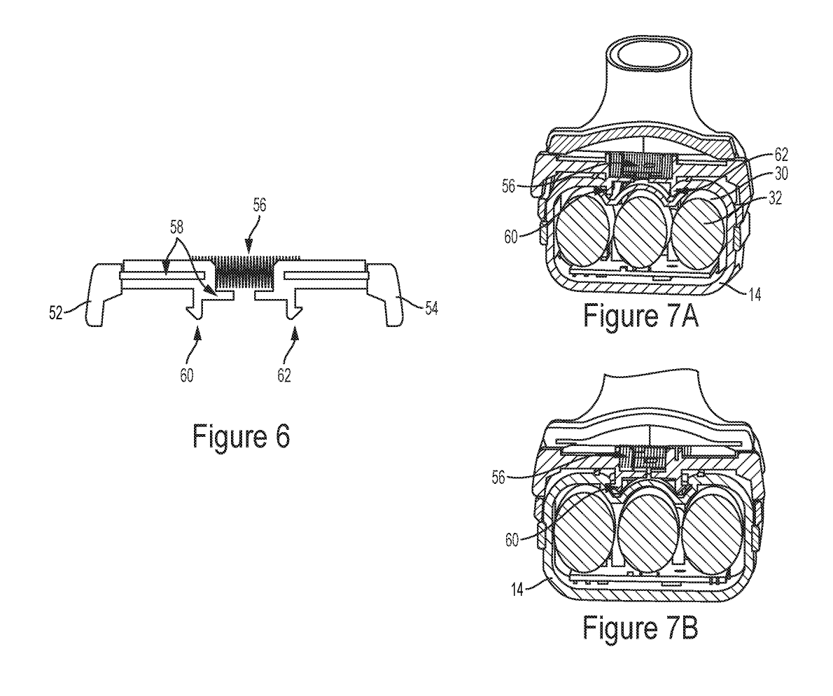

Referring to FIG. 1 through FIG. 12, there is illustrated a first exemplary embodiment of a new power tool and battery pack system. This system was designed to create a new family of products that all utilize a new battery pack design, as well as implement a new latching system. With regard to the battery pack, the overall height and footprint have both been decreased substantially. With this reduction in size, the battery pack that is now thin enough to be placed in a pocket and carried around with the user. To add to the usability of a pack that can now go with you everywhere, a USB Type C port is included that can be used to both charge and discharge the battery. This dual functionality of the port will also allow the user to charge any personal electronics that utilize USB, off of the battery pack as well. All of this added functionality serves to elevate this new battery pack design into a stand-alone product with many more uses than just powering a tool.

Decreased height and footprint of battery pack to increase the ease with which it can be carried around by the user. To take advantage of USB C addition, battery must be easy to put in pocket and keep on your person throughout the day.

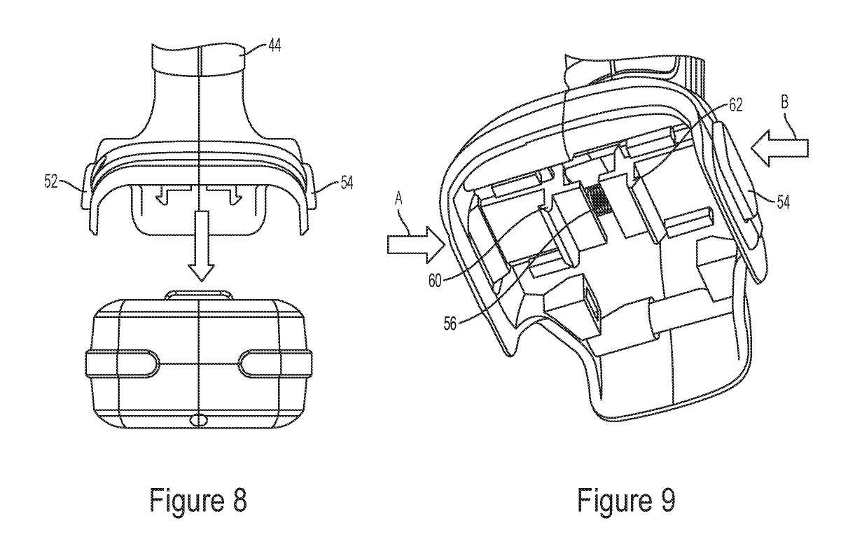

Referring to FIG. 6, Ribs used to limit button travel into and out of the tool; Compression spring for holding battery to tool; Force from battery central latching system when connecting battery compresses spring until the feet engage and the spring is allowed to expand and hold the battery in the tool

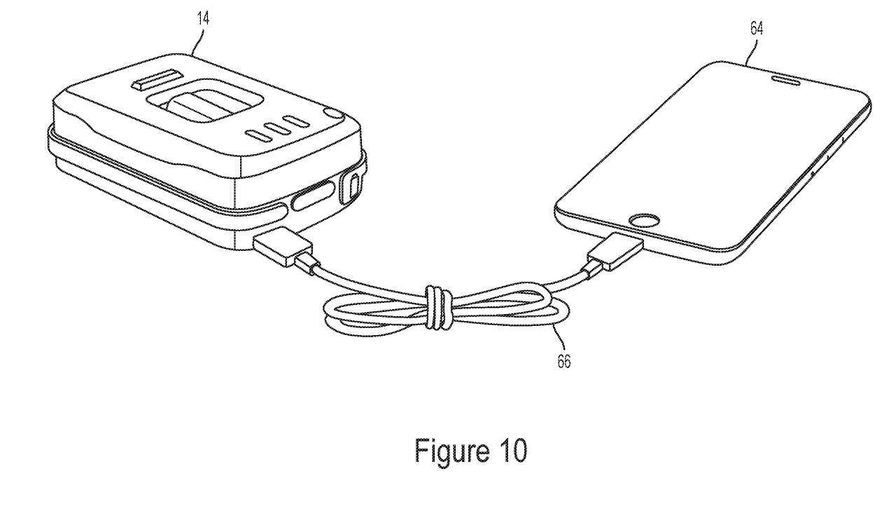

Referring to FIG. 7A, Latch engaged, battery secure in tool. Referring to FIG. 7B,

Latch disengaged, battery released from tool.

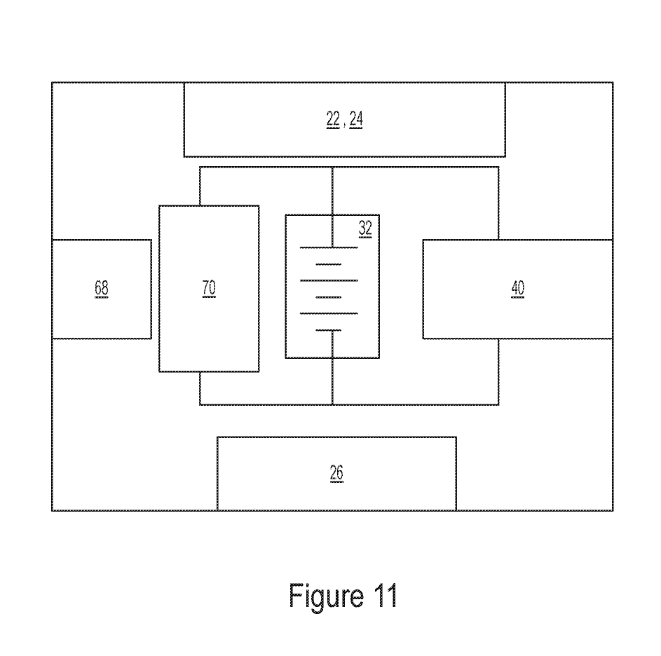

Referring to FIG. 8, Connect Battery—Push tool foot down onto the battery pack. The downward force causes the spring to compress and allows the feet on the buttons to engage the central latching system on the battery.

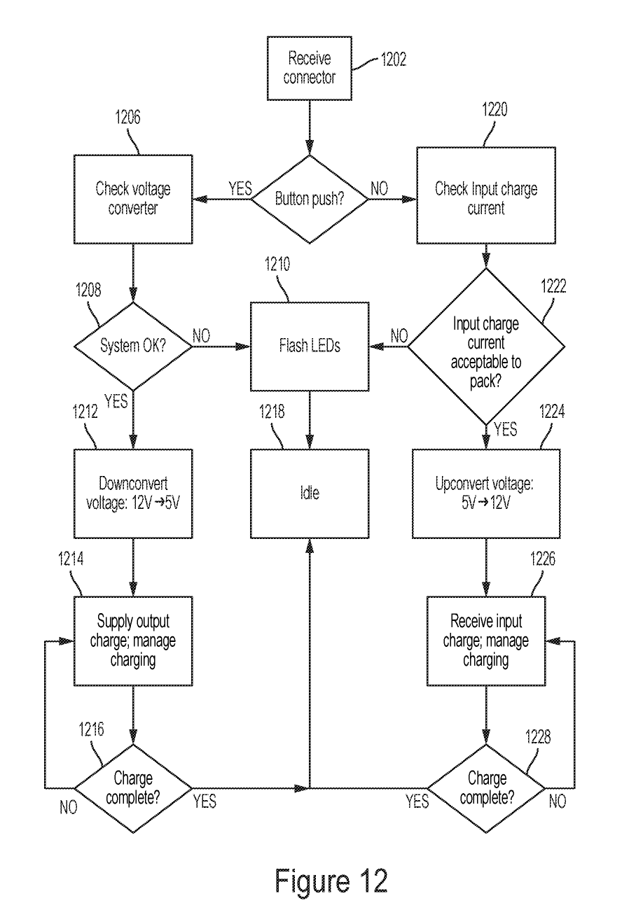

Referring to FIG. 9, Disconnect battery—Press in the two buttons on either side of the foot simultaneously to compress the spring and release the tool from the central latching system of the battery.

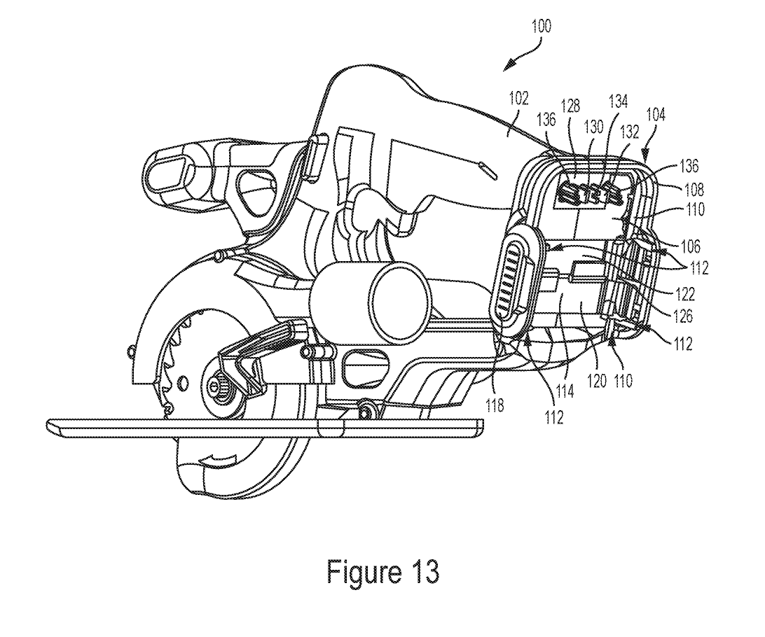

Referring to FIG. 10, the battery pack 14 is shown electrically coupled to an battery operated electrical device 64, such as a cell phone. Other battery operated devices, such as watch, navigation system or camera may be coupled to the battery pack 14. The battery pack 14 may operate as a source of electrical energy to charge the electrical device 64.

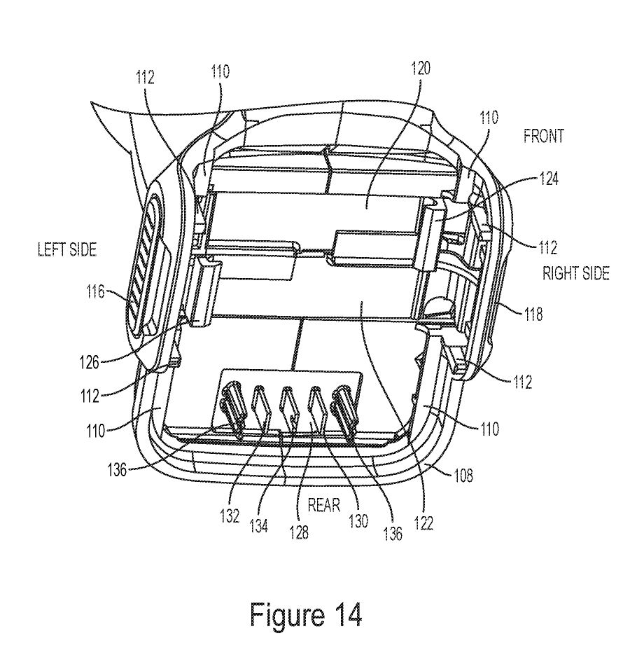

Referring to FIG. 11, the battery pack may include an optional Qi (WPC) input 68 for wireless charging of the cells 32. The output—the power tool output 40 and/or the USB output 22—can be disabled while the battery cells 32 are charging from the USB input 22. The USB port 22 may be configured as a current source (to charge an external device 64, for example a cell phone) or a current sink (to charge the internal battery cells 32) by a user selectable switch 24. The state of charge (SoC) indicator 26 may automatically display the status of the internal battery cells 32 during charge and/or discharge—either through the USB port 22 or the power tool terminals 40. The SoC indicator 26 may also only display the status of the internal battery cells 32 when an activation switch is operated.

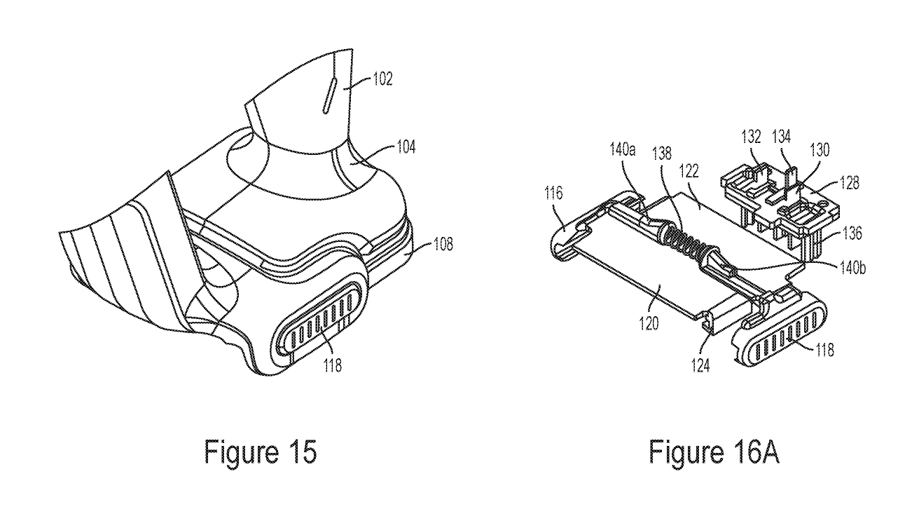

FIG. 12 illustrates a flow chart for the charging and discharging scheme using the input/output port 22.

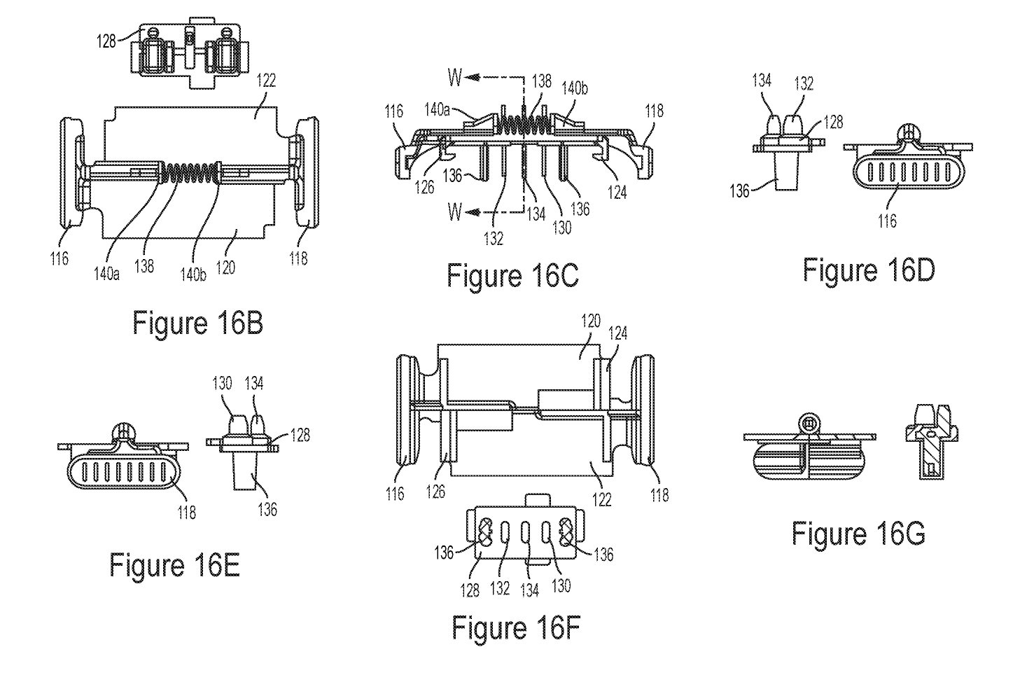

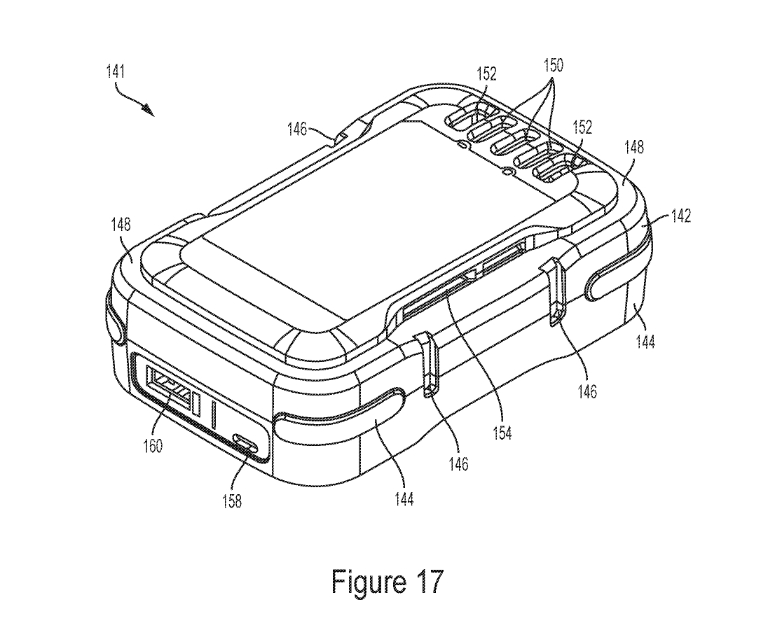

FIG. 13 through 16 illustrate a second, exemplary power tool 100 of the set of power tools of a new power tool system. The illustrated power tool 100 is a circular saw. Other power tool may be included in the set of power tools, for example, a drill, a hammerdrill, a glue gun, a stapler, a jigsaw, a light and an orbital sander. Other tools are contemplated.

The power tool 100 includes a tool housing 102. The tool housing 102 includes a tool foot 104. The tool foot 104 includes a battery pack interface 106. The battery pack interface 106 may include a shroud 108 that may surround a portion of an attached battery pack. The battery pack interface may also include a positive stop surface 110. The positive stop surface 110 engages a surface of an attached battery pack at a fixed location to assist in coupling the power tool 100 to the battery pack.

The battery pack interface 106 may also include a set of alignment rails 112. The alignment rails 112 also assist in coupling the power tool 100 to the battery pack. The alignment rails 112 cooperate with a corresponding set of alignment slots (discussed in further detail below) on the battery pack.

The battery pack interface 106 includes a latch assembly 114. The latch assembly 114 cooperates with a corresponding set of catches on the battery pack (discussed in more detail below). The latch assembly 114 includes a pair of buttons—A button 116 and B button 118—that may be operated by a user to operate the latch assembly 114. The buttons 116, 118 are positioned on opposing sides of the battery pack interface 106. The buttons 116, 118 may be incorporated in the shroud 108. Each button 116, 118 is positioned in a through hole (cavity) in the tool foot 104 or in the shroud 108.

The latch assembly 114 further includes a pair of latch arms—A latch arm 120 and B latch arm 122 connected to the corresponding, respective button 116, 118. The latch arms 120, 122 extend parallel and adjacent to each other away from their respective buttons 116, 118. Each latch arm 120, 122 terminates in a corresponding latch—A latch 124 and B latch 126. Each latch 124, 126 includes a hook curling into or towards a central region of the battery pack interface 106. More particularly, each hook curls towards its corresponding button. Specifically, the A hook curls towards the A button 116 and the B hook curls towards the B button 118. The latches 124, 126 and the corresponding hooks are received in catches in the battery pack (discussed in more detail below).

The battery pack interface 106 also includes a tool terminal block 128. The tool terminal block 128 may be made of a durable plastic and serves to fix a plurality of electrical terminals in a fixed position relative to each other and the battery pack interface 106. The tool terminal block 128 includes a positive tool terminal 130 coupled to a positive node of a load, for example a tool motor or light fixture, of the power tool 100 and a negative tool terminal 132 coupled to a negative node of the load and a thermistor terminal 134 coupled to control module of the power tool 100. The positive and negative terminals 130, 132 are positioned and configured to mate with corresponding battery terminals to provide energy from a battery pack to the load to operate the power tool (discussed in more detail below). The thermistor terminal 134 may receive temperature information from a thermistor in the battery pack that may be used by the tool for operation of the battery. The terminal block 128 also includes a pair of alignment posts 136. These alignment posts 136 serve to align the power tool 100 with a battery pack when the power tool is coupling to the battery pack to insure that the power tool terminals 130, 132, 134 properly mate with the corresponding terminals of the battery pack.

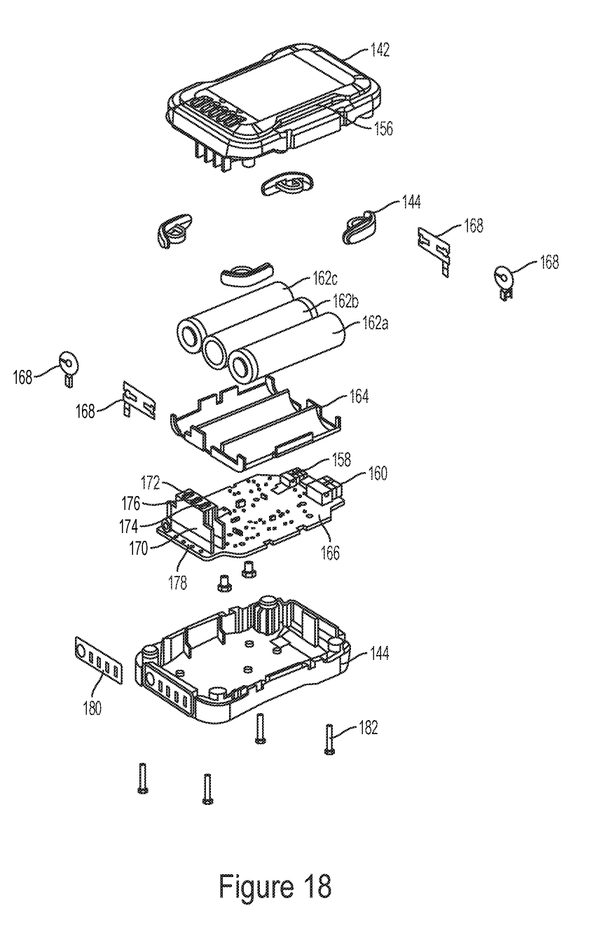

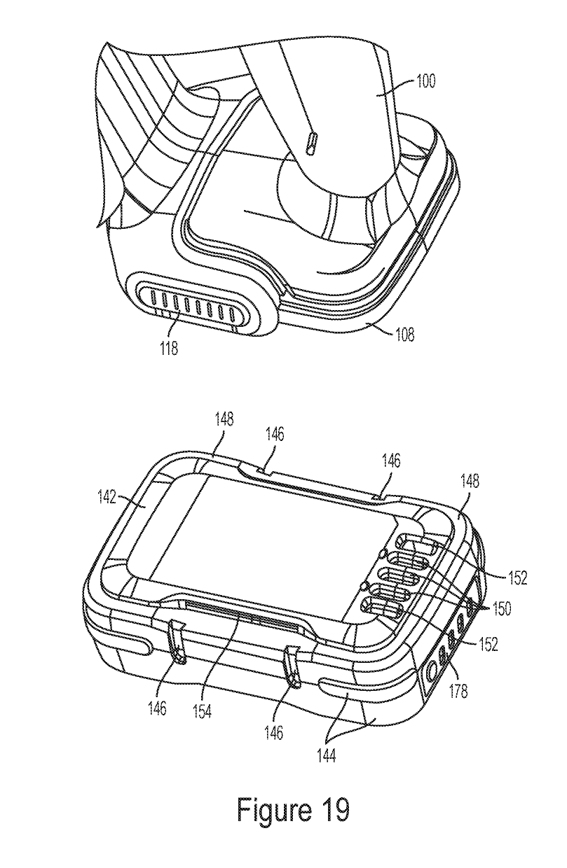

As illustrated in FIGS. 15 and 16A through 16G, the latching assembly 114 and the terminal block 128 are positioned in the tool foot 104 and particularly in the battery pack interface 106. FIG. 15 illustrates the power tool foot 104 including the latch assembly 114 therein and FIG. 16A illustrates the latch assembly 114 and the terminal block 128 with the tool housing 102 removed. FIGS. 16A (top, right perspective view), 16B (front elevation view) and 16C (top plan view) clearly illustrate several elements of the latch assembly 114 and terminal block 128. As illustrated, each latch arm 120, 122 includes a corresponding spring stop 140a, 140b. A compression spring 138 is positioned between and held in place by the spring stops 140a, 140b. The compression spring 138 is compressed just enough to force the latch arms 120, 122 away from each other such that the latches 124, 126 are inserted into corresponding catches in the battery pack (discussed in more detail below).

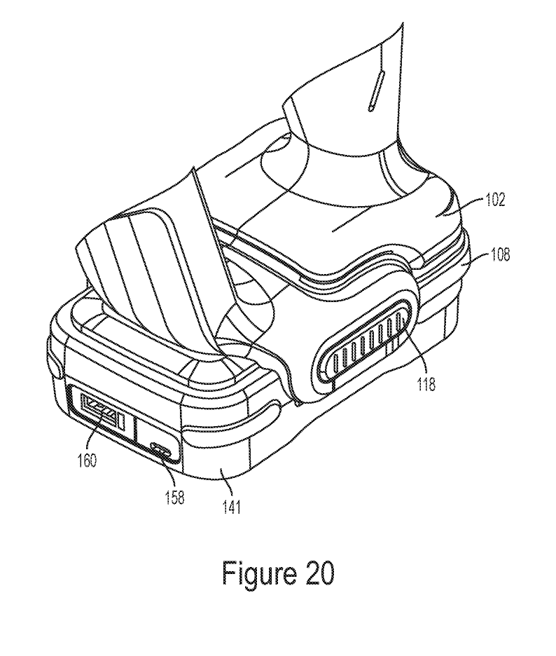

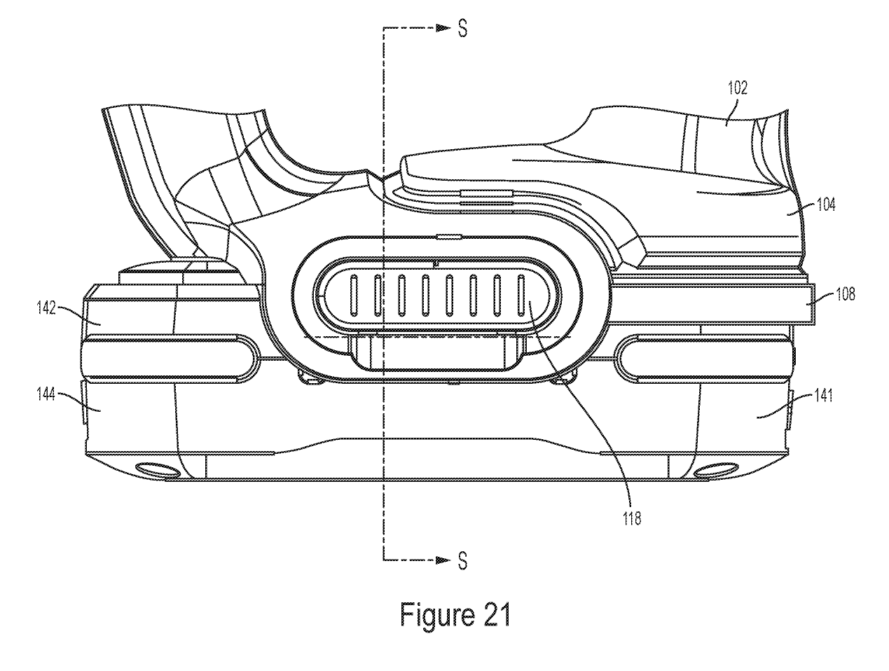

FIGS. 17 and 18 illustrate an exemplary battery pack 141 for use with the power tool 100. The battery pack 141 includes a top/upper housing 142 and a bottom/lower housing 144. The housings 142, 144 may be made of a durable plastic and configured to sealing couple together. The top and bottom housings 142, 144 may be referred to herein as a housing. The battery pack 141 also may include a set of housing bumpers 144 to protect the battery pack 141 from damage during misuse. The battery housing may include a set of alignment slots 146. The alignment slots are positioned and configured to cooperate with and receive the alignment rails 112 in the battery pack interface 106. The battery housing may also include one or more positive stop surfaces 148 positioned and configured to cooperate with and abut with the positive stop surfaces 110 of the battery pack interface 106. The battery housing may also include a set of housing terminal slots/through holes 150 positioned and configured to cooperate with and receive the tool terminals 130, 132, 134 to enable the tool terminals to mate with the battery pack terminals. The battery housing may also include a set of alignment post slots/through holes 152 positioned and configured to cooperate with and receive the alignment posts 136 of the battery pack interface 106.

The battery pack housing includes a pair of catches—A catch 154 and B catch 156—configured and positioned to cooperate with and receive the corresponding latches 124, 126, respectively.

The battery pack also includes a pair of electrical ports—the housing includes a corresponding pair of openings for access to the ports. A first port 158 is an input port for providing (sinking) energy from an external power supply to the internal battery pack cells. The input port 158 may be, for example, a USB type B port. A second port 160 is an output port for supplying (sourcing) energy from the internal battery pack cells to an external battery. The output port 160 may be, for example, a USB type A port.

FIG. 18 illustrates an exploded view of the battery pack 141 showing the internal components of the battery pack 141. The battery pack 141 includes a set of battery cells 162. This exemplary battery pack includes three battery cells 162a, 162b, 162c. Alternate packs may include fewer or more cells. The cells 162 are positioned in and held in place by a cell holder/cradle 164. The cell holder 164 is attached to a printed circuit board 166. The PCB 166 is populated by various electronic components configured to operate the battery pack 141. The battery pack also includes a set of battery straps 168. The battery straps 168 connect the battery cells 162, in this instance in series, and couple the battery cells 162 to the PCB 166. The battery pack 141 also includes a terminal block 170. The battery pack terminal block 170 is coupled to the PCB 166 and holds a positive battery terminal 172 coupled to a positive node of the set of battery cells 162 via the PCB 166 and a negative battery terminal 174 coupled to a negative node of the set of battery cells 162 via the PCB 166 and a thermistor terminal 176 coupled to a thermistor on the PCB 166.

The battery pack also includes a set of LEDs 178 for displaying the state of charge (SoC) of the battery cells 162. The battery pack also includes a switch for activating the SoC and a cover 180 for covering the LEDs 178. The battery pack 141 also includes a set of fasteners 180 for coupling the top and bottom housings 142, 144 and the PCB 166 and cradle 164 to each other.

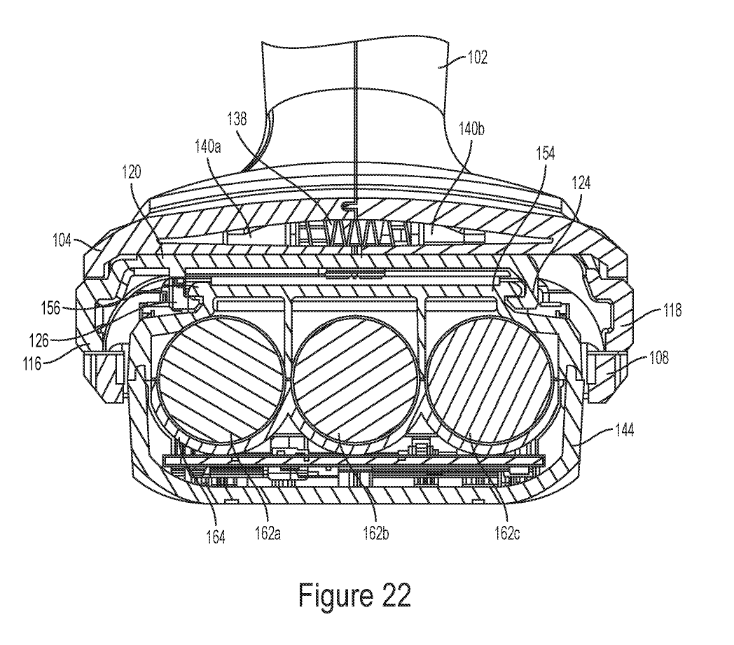

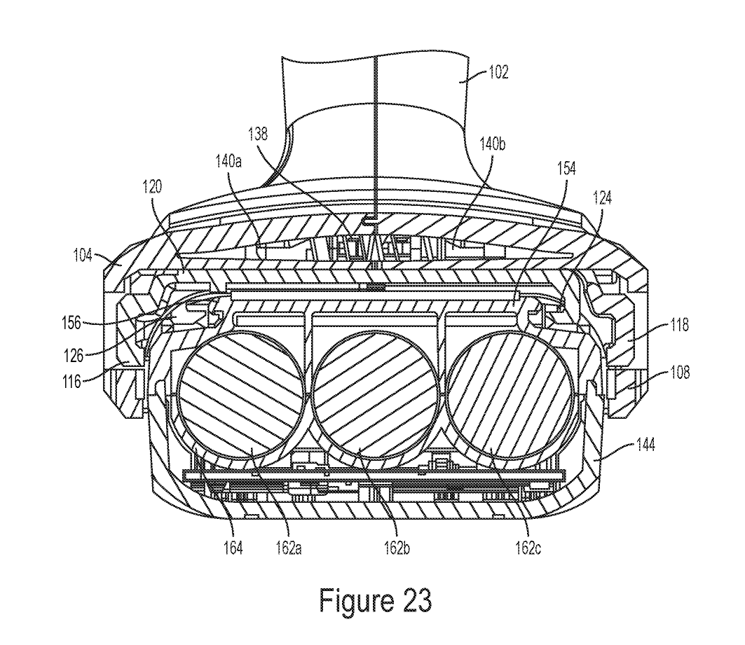

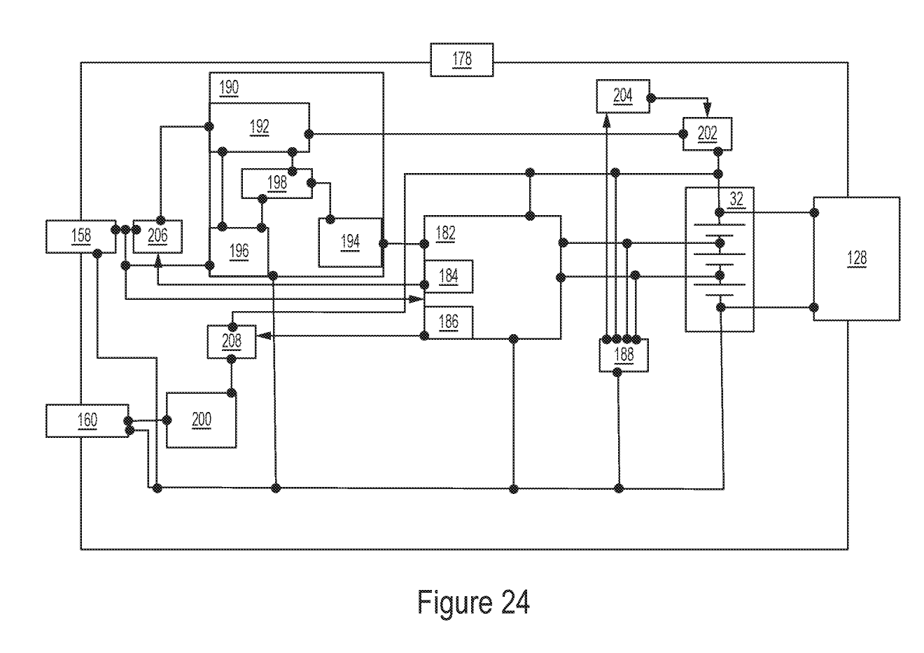

As illustrated in FIGS. 19, 20, and 21, the battery pack 141 is mated/coupled to the power tool 100. To mate the battery pack 141 and power tool 100, the latch arms 120, 122 must move in opposing directions, towards the other button, thereby compressing the spring 138 and moving the latches 124, 126 away from each other. This movement allows the latches 124, 126 move past an outer lip of the corresponding catch and align with a concave recess of the catch. The movement of the latches may be achieved by a user pressing the buttons 116, 118 towards each other—thereby compressing the spring 138—and moving the latch arms 120, 122 in opposing directions and the latches 124, 126 away from each other. And, simultaneously, moving the battery pack 141 into the battery pack interface 106 while aligning the power tool alignment rails 112 with the battery pack alignment slots 146 and the power tool alignment posts 136 with the battery pack alignment post slots 152. Once the battery pack 141 is fully seated in the battery pack interface 106 the user may release the buttons 116, 118. This will allow the spring 138 to decompress—forcing the latch arms 120, 122 to move back to their rest positions and the latches 124, 126 to move towards each other and into the concave recesses of the corresponding catches 154, 156.

The battery pack 141 may also be inserted into the power tool simply by pressing the battery pack 141 into the battery pack interface 106 and using the lips of the catches 154, 156 for force the corresponding hooks for the latches 124, 126 away from each other until the hooks pass over the lips and into the concave recesses.

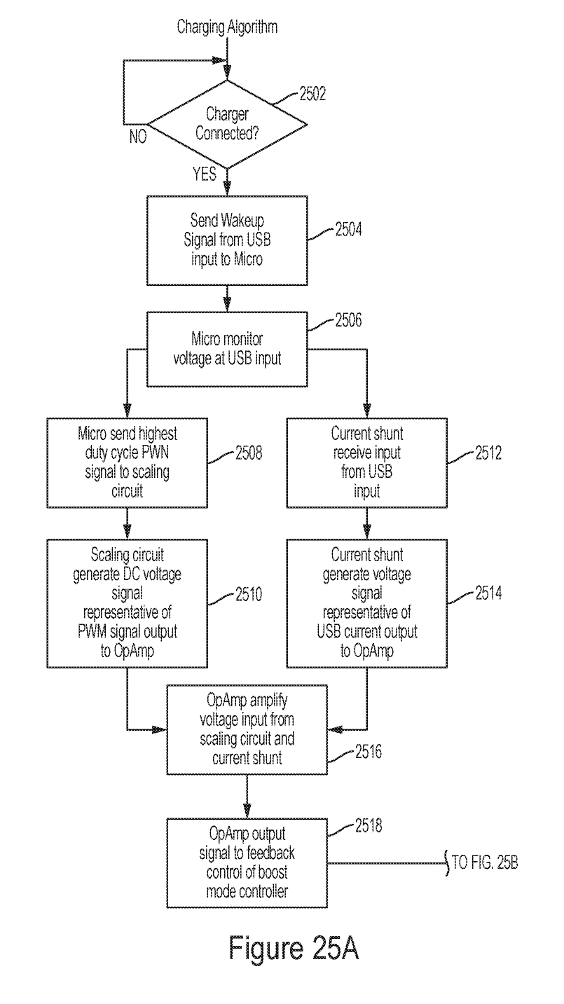

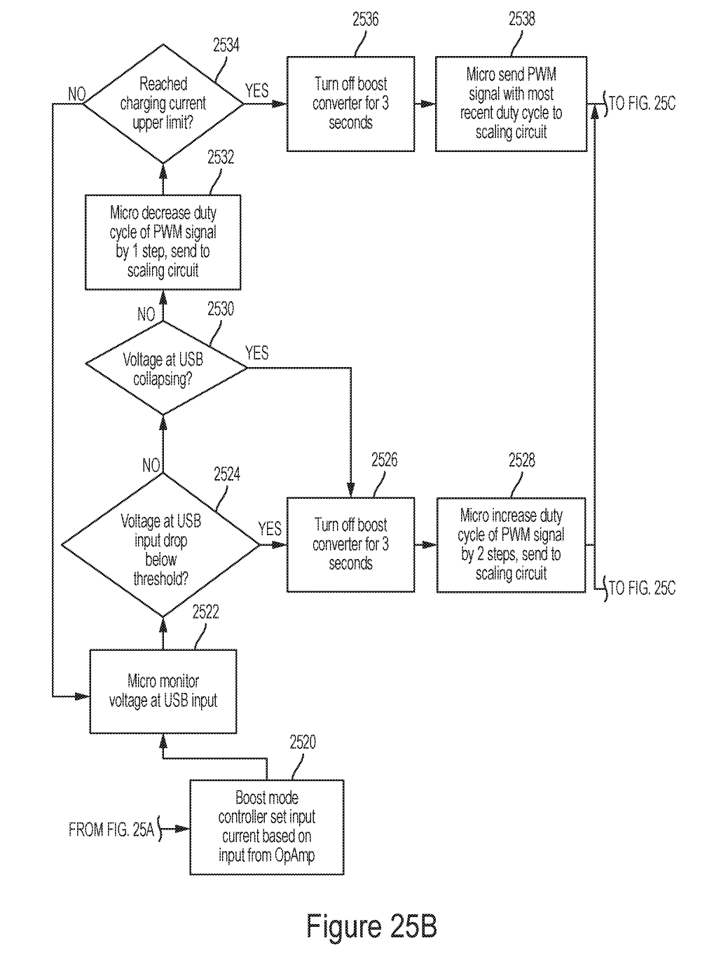

As illustrated in FIG. 22, the hooks of the latches 124, 126 are positioned in the concave recesses of the corresponding catches 154, 156. The buttons 116, 118 are forces apart from each other by the force of the slightly compressed spring 138. As such, the battery pack 141 is affixed to the power tool 100 by the latch assembly 114. As illustrated in FIG. 23, the buttons 116, 118 are moved towards each, thereby compressing the spring 138, moving the latch arms 120, 122 in opposing directions and the latches 124, 126 away from each other and out of the respective catches 154, 156. In this position, the battery pack 141 may be removed from the power tool 100.

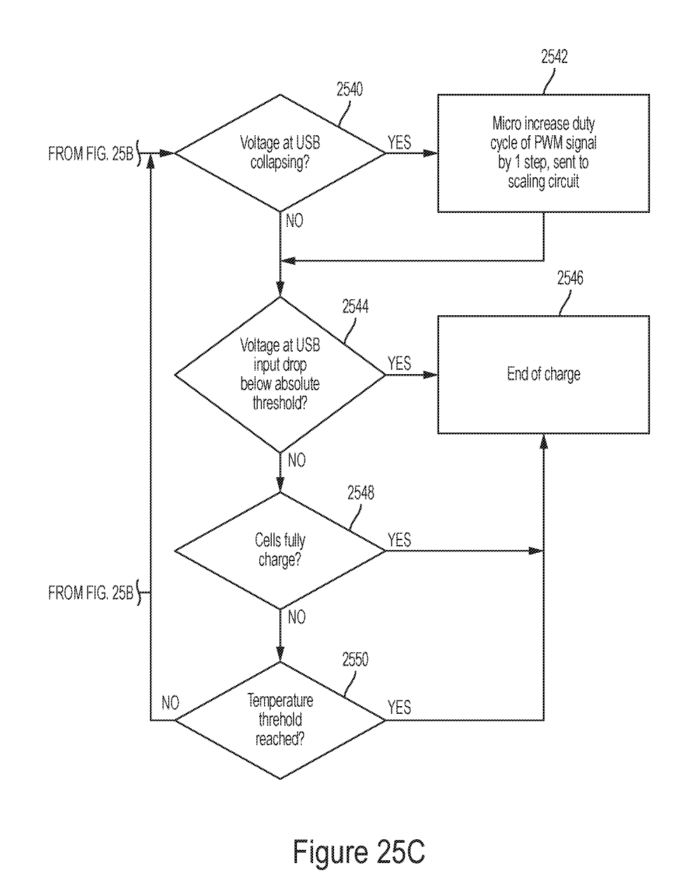

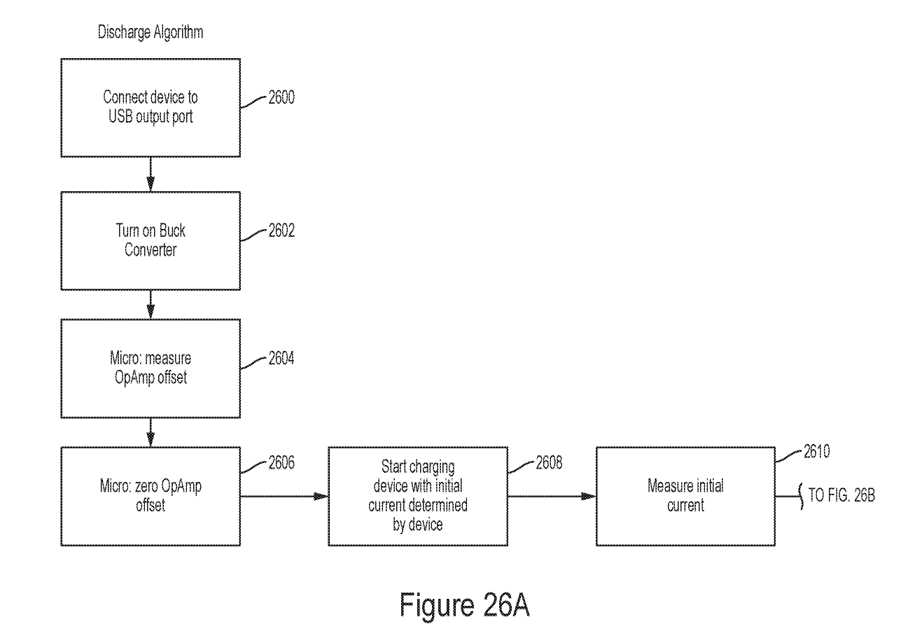

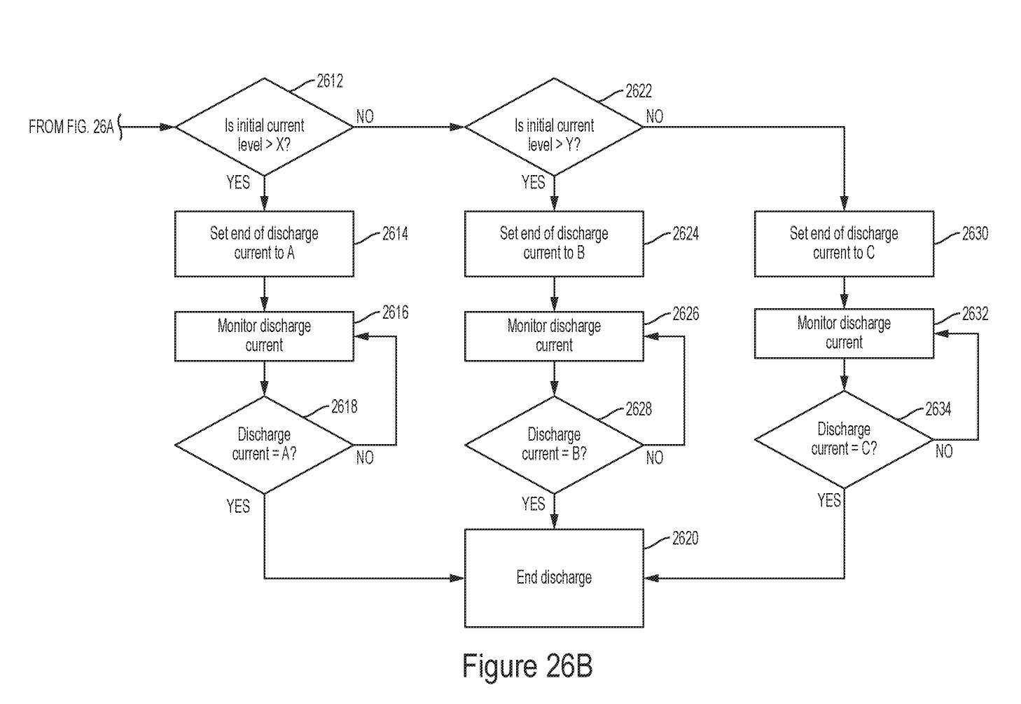

FIG. 24 illustrates an exemplary, simplified block diagram of the battery pack. The battery pack 141 includes a microprocessor or microcontroller 182. The microprocessor 182 includes a primary overvoltage protection chip/circuitry 184 to monitor and control the charging process of the battery cells 32 and an undervoltage protection chip/circuitry 186 to monitor and control the discharging process of the battery cells 32. The battery pack also includes a secondary overvoltage protection chip/circuitry 188 to monitor and control the charging process of the battery cells 32. The battery pack 141 also includes a boost converter 190 coupled to the input port 158 to provide a charging current to the battery cells 32. The boost converter 190 includes a boost mode controller 192, a scaling circuit 194, a current shunt 196 and an operation amplifier 198. The battery pack 141 also includes a buck converter 200 to provide a discharging current from the battery cells 32 to an external battery pack.

The microprocessor 182 and/or the secondary overvoltage protection chip 188 may control various switches 202, 204, 206, and 208 to control the charging and discharging of the battery cells 32.

Numerous modifications may be made to the exemplary implementations described above. These and other implementations are within the scope of this application.

1. A power tool and battery pack system, comprising:
a power tool having a latching assembly comprising a pair of buttons, each button coupled to a corresponding latch, wherein moving the buttons towards each other moves the latches away from each other,
a battery pack comprising a pair of catches, wherein the catches are positioned on opposing sides of the battery pack to receive the latches to affix the battery pack to the power tool.
